(19) United States
(12) Patent Application Publication
(10) Pub. No.: US 2008/0300387 A1
(43) Pub. Date: Dec. 4, 2008

(54) Organometallic Framework Materials of Transition Group III

(75) Inventors: Markus Schubert, Ludwigshafen (DE); Ulrich Muller, Neustadt (DE); Stefan Marx, Berlin (DE); Rainer Senk, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/093,961

(22) PCT Filed: Nov. 14, 2006
(86) PCT No.: PCT/EP2006/068446

§ 371 Date: May 16, 2008

(30) Foreign Application Priority Data
Nov. 16, 2005 (DE) 102005054636.6

(51) Int. Cl. C07F 19/00

(52) U.S. Cl. 534/16; 534/15

(57) ABSTRACT

The present invention relates to a process for preparing a porous metal organic framework, which comprises the step:

Reaction of at least one metal compound with at least one at least bidentate organic compound which can coordinate to the metal, where the metal is Sc^{III}, Y^{III} or a trivalent lanthanide and the organic compound has at least two atoms which are selected independently from the group consisting of oxygen, sulfur and nitrogen and via which the organic compound can coordinate to the metal, in the presence of a nonaqueous organic solvent, with the reaction being carried out with stirring and at a pressure of not more than 2 bar (absolute).

The invention further relates to porous metal organic frameworks which have been prepared by this process and their use.

The present invention relates to a process for preparing a porous metal organic framework and the use of the frameworks prepared.

Porous metal organic frameworks are known in the prior art. These typically comprise at least one at least bidentate organic compound coordinated to at least one metal ion. Such metal organic frameworks (MOFs) are described, for example, in U.S. Pat. No. 5,648,508, EP-A 0 790 253, M. O. Keeffe, J. Sol. State Chem., 152 (2000), 3-20; H. Li et al., Nature 402 (1999), 276; M. Eddaoudi, Topics in catalysis 9 (1999), 105-111; B. Chen et al., Science 291 (2001), 1021-1023 and DE-A 101 11 230.

Numerous methods of preparing such porous metal organic frameworks have been developed. Typically, a metal salt is reacted with the at least bidentate organic compound, for example a dicarboxylic acid, in a suitable solvent under superatmospheric pressure and at elevated temperature. This is frequently achieved by placing the reaction mixture in a pressure vessel, e.g. an autoclave, and then closing this so that an appropriate pressure is generated in the reaction space of the pressure vessel when the temperature is increased. These temperatures are frequently above 200° C. Such reaction conditions are frequently referred to as hydrothermal conditions in the literature.

However, difficulties frequently occur here. One problem can be that, owing to the use of a metal salt, the counterion to the metal cation (for example nitrate) which remains in the reaction medium after formation of the metal organic framework has to be separated off from the framework.

As a result of the use of high pressures and temperatures, high demands are placed on the apparatus used for synthesizing a porous metal organic framework. Only a batch synthesis in comparatively small apparatuses is usually possible and has usually been described. A scale-up is found to be very complicated.

Furthermore, it has been found that, depending on the method of preparation, the porous metal organic framework formed can differ significantly from frameworks which are based on the same metal ion and on the same at least bidentate organic compound but have been produced in another way.

However, this observation also presents the possibility of producing frameworks which comprise known metals or metals unknown for frameworks and organic compounds and can have particularly useful properties for particular applications by appropriate variation of the production conditions.

Such an interesting group of metal organic frameworks are ones in which the metal ion comes from the third transition group of the Periodic Table.

L. Pan et al., J. Am. Chem. Soc. 125 (2003), 3062-3067, describe frameworks which use terephthalic acid as organic compound and lanthanum or erbium as metal ion. These are prepared under hydrothermal conditions.

In ES-A 2200681, metal-organic rare earth disulfonates are prepared under hydrothermal conditions.

Furthermore, S. R. Miller et al., Chem. Commun. 2005, 3850-3852, describe the hydrothermal preparation of scandium terephthalate.

T. M. Reineke et al. are concerned with metal organic frameworks based on terbium (cf., for example, J. Am. Chem. Soc. 121 (1999), 1651-1657; Angew. Chem. 111 (1999), 2712-2716).

C. Serre et al., J. Mater. Chem. 14 (2004), 1540-1543, describe the hydrothermal preparation of europium-doped yttrium benzenetricarboxylate.

Porous metal organic frameworks based on praseodymium, europium and terbium are described by X. Zheng et al., Eur. J. Inorg. Chem. 2004, 3262-3268.

However, there is still a need for metal organic frameworks which are based on the abovementioned metal ions but have properties which can be particularly advantageous for particular applications. Such applications can be the storage, separation or controlled release of substances, in particular gases, or be related to chemical reactions or be based on the function of the frameworks as support material.

It is therefore an object of the present invention to provide an improved process for preparing such porous metal organic frameworks.

This object is achieved by a process for preparing a porous metal organic framework, which comprises the step:

Reaction of at least one metal compound with at least one at least bidentate organic compound which can coordinate to the metal, where the metal is Sc^{III}, Y^{III} or a trivalent lanthanide and the organic compound has at least two atoms which are selected independently from the group consisting of oxygen, sulfur and nitrogen and via which the organic compound can coordinate to the metal, in the presence of a nonaqueous organic solvent, with the reaction being carried out with stirring and at a pressure of not more than 2 bar (absolute).

It has surprisingly been found that the use of the above-described conditions in the process of the invention for preparing a porous metal organic framework makes it possible to obtain novel frameworks which have a comparatively low BET surface area determined by the Langmuir method (N₂) but display surprisingly good results in the storage of hydrogen. This is all the more surprising since the ability of metal organic frameworks to store a gas normally correlates with the specific surface area.

An advantage of the process is, inter alia, that the reaction can take place with stirring, which is also advantageous for scale-up.

The reaction is carried out at a pressure of not more than 2 bar (absolute). However, the pressure is preferably not more than 1230 mbar (absolute). The reaction particularly preferably takes place at atmospheric pressure.

The reaction can be carried out at room temperature. However, it preferably takes place at temperatures above room temperature. The temperature is preferably more than 100° C. Furthermore, the temperature is preferably not more than 180° C. and more preferably not more than 150° C.

The above-described metal organic frameworks are typically prepared in water as solvent with addition of a further base. This serves, in particular, to make a polybasic carboxylic acid used as at least bidentate organic compound readily soluble in water. The use of the nonaqueous organic solvent makes it unnecessary to use such a base. Nevertheless, the solvent for the process of the invention can be chosen so that it itself has a basic reaction, but this is not absolutely necessary for carrying out the process of the invention.

It is likewise possible to use a base, but it is preferred that no additional base is used.

It is also possible, in a preferred embodiment, for the metal compound used for preparing the porous metal organic framework to be nonionic and/or for the counterion to the metal cation to be derived from a protic solvent. When an appropriately chosen nonionic compound is used, it is possible to avoid a situation where the metal is present in the form of a salt in the reaction to form the porous metal organic framework and difficulties may therefore occur in the removal of the corresponding anion in the metal salt, as long as the metal compound produces no further interfering salts in the reaction. If the counterion is an appropriately chosen solvent anion, it can be present after the reaction as solvent which can be identical to the nonaqueous organic solvent used or be different therefrom. In the latter case, it is preferred that this solvent is at least partially miscible with the nonaqueous organic solvent. If water is formed in the reaction of the metal compound, its proportion should be within the limits described below. This can be achieved by a sufficient amount of the nonaqueous organic solvent being used.

Nevertheless, this synthesis also works when classical salts such as nitrates or halides are used.

Such nonionic compounds or counterions to the metal cation which can be derived from protic solvents can be, for example, metal alkoxides, for example methoxides, ethoxides, propoxides, butoxides. Oxides or hydroxides are likewise conceivable.

The metal used is Sc^{III}, Y^{III} or a trivalent lanthanide. Preference is given to the metal ions Sc^{III}, Y^{III}, La^{III}, Nd^{III} and Ce^{III}. Particular preference is given to Sc^{III} and Y^{III}. The metals used can also be employed as mixtures.

The at least one at least bidentate organic compound has at least two atoms which are selected independently from the group consisting of oxygen, sulfur and nitrogen and via which the organic compound can coordinate to the metal. These atoms can be part of the skeleton of the organic compound or be functional groups.

As functional groups via which the abovementioned coordinate bonds may be formed, mention may be made by way of example and in particular of the following functional groups: OH, SH, NH₂, NH(—R—H), N(R—H)₂, CH₂OH, CH₂SH, CH₂NH₂, CH₂NH(—R—H), CH₂N(—R—H)₂, —CO₂H, COSH, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H₂, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, where R is, for example and preferably, an alkylene group having 1, 2, 3, 4 or 5 carbon atoms, for example a methylene, ethylene, n-propylene, i-propylene, n-butylene, i-butylene, tert-butylene or n-pentylene group, or an aryl group having 1 or 2 aromatic rings, for example 2C₆ rings, which may, if appropriate, be fused and may be appropriately substituted, independently of one another, by at least one substituent and/or may comprise, independently of one another, in each case at least one heteroatom such as N, O and/or S. In likewise preferred embodiments, functional groups in which the abovementioned radical R is not present are also possible. In this respect, mention may be made of, inter alia, —CH(SH)₂, —C(SH)₃, —CH(NH₂)₂, CH(NH(R—H))₂, CH(N(R—H)₂)₂, C(NH(R—H))₃, C(N(R—H)₂)₃, —C(NH₂)₃, —CH(OH)₂, —C(OH)₃, —CH(CN)₂, —C(CN)₃.

The at least two functional groups can in principle be bound to any suitable organic compound as long as it is ensured that the organic compound bearing these functional groups is capable of forming the coordinate bond and of producing the framework.

The organic compounds comprising the at least two functional groups are preferably derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. More preferably, the aliphatic compound or the aliphatic part of the both aliphatic and aromatic compound comprises from 1 to 18, more preferably from 1 to 14, more preferably from 1 to 13, more preferably from 1 to 12, more preferably from 1 to 11 and particularly preferably from 1 to 10, carbon atoms, for example 1, 2, 3, 4, 5, 6, 7, 8, 9 or 10 carbon atoms. Particular preference is given to, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings can be present in fused form. Particular preference is given to the aromatic compound or the aromatic part of the both aliphatic and aromatic compound having one, two or three rings, with one or two rings being particularly preferred. Furthermore, the rings of the compound mentioned can each comprise, independently of one another, at least one heteroatom such as N, O, S, B, P, Si, preferably N, O and/or S. More preferably, the aromatic compound or the aromatic part of the both aromatic and aliphatic compound comprises one or two C₆ rings, with the two rings being present either separately from one another or in fused form. Aromatic compounds which may be mentioned are, in particular, benzene, naphthalene and/or biphenyl and/or bipyridyl and/or pyridyl.

The at least bidentate organic compound is particularly preferably derived from a dicarboxylic, tricarboxylic or tetracarboxylic acid or a sulfur analogue thereof. Sulfur analogues are the functional groups —C(═O)SH and its tautomer and C(═S)SH, which can be used in place of one or more carboxyl groups.

For the purposes of the present invention, the term “derived” means that the at least bidentate organic compound can be present in partly deprotonated or fully deprotonated form in the framework. Furthermore, the at least bidentate organic compound can comprise further substituents, for example —OH, —NH₂, —OCH₃, —CH₃, —NH(CH₃), —N(CH₃)₂, —CN and halides.

The at least bidentate organic compound is more preferably an aliphatic or aromatic acyclic or cyclic hydrocarbon which has from 1 to 18 carbon atoms and also has exclusively at least two carboxyl groups as functional groups.

For the purposes of the present invention, mention may be made of, for example, dicarboxylic acids such as

oxalic acid, succinic acid, tartaric acid, 1,4-butanedicarboxylic acid, 1,4-butenedicarboxylic acid, 4-oxopyran-2,6-dicarboxylic acid, 1,6-hexane-dicarboxylic acid, decanedicarboxylic acid, 1,8-heptadecanedicarboxylic acid, 1,9-heptadecanedicarboxylic acid, heptadecanedicarboxylic acid, acetylene-dicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methyl-quinoline-2,3-dicarboxylic acid, 1-anilinoanthraquinone-2,4′-dicarboxylic acid, polytetrahydrofuran 250-dicarboxylic acid, 1,4-bis(carboxymethyl)piperazine-2,3-dicarboxylic acid, 7-chloroquinoline-3,8-dicarboxylic acid, 1-(4-carboxy)-phenyl-3-(4-chlorophenyl)pyrazoline-4,5-dicarboxylic acid, 1,4,5,6,7,7-hexa-chloro-5-norbornene-2,3-dicarboxylic acid, phenylindanedicarboxylic acid, 1,3-dibenzyl-2-oxoimidazolidine-4,5-dicarboxylic acid, 1,4-cyclohexane-dicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-tri-oxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, (bis(4-aminophenyl)ether)diimidedicarboxylic acid, 4,4′-diaminodiphenylmethanediimidedicarboxylic acid, (bis(4-aminophenyl)sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-di-phenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-hepta-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-di-hydroanthracene-2,3-dicarboxylic acid, 2,5-pyridinedicarboxylic acid, cyclohexene-2,3-dicarboxylic acid, 2,9-dichlorofluororubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-di-carboxylic acid, 1,14-tetradecanedicarboxylic acid, 5,6-dehydronorbornane-2,3-dicarboxylic acid, 5-ethyl-2,3-pyridinedicarboxylic acid or camphor-dicarboxylic acid,

tricarboxylic acids such as

2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo-[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid,

or tetracarboxylic acids such as

1,1-dioxoperylo[1,12-BCD]thiophene-3,4,9,10-tetracarboxylic acid, perylenetetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

Very particular preference is given to optionally at least monosubstituted aromatic dicarboxylic, tricarboxylic or tetracarboxylic acids having one, two, three, four or more rings, with each of the rings being able to comprise at least one heteroatom and two or more rings being able to comprise identical or different heteroatoms. For example, preference is given to single-ring dicarboxylic acids, single-ring tricarboxylic acids, single-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, P, and preferred heteroatoms are N, S and/or O, Suitable substituents in these compounds are, inter alia, —OH, a nitro group, an amino group or an alkyl or alkoxy group.

As at least bidentate organic compounds, particular preference is given to using acetylenedicarboxylic acid (ADC), camphordicarboxylic acid, fumaric acid, succinic acid, benzenedicarboxylic acids, naphthalenedicarboxylic acids, biphenyldicarboxylic acids such as 4,4′-biphenyldicarboxylic acid (BPDC), pyrazinedicarboxylic acids such as 2,5-pyrazinedicarboxylic acid, bipyridinedicarboxylic acids such as 2,2′-dipyridinedicarboxylic acids, such as 2,2′-dipyridine-5,5′-dicarboxylic acid, benzenetricarboxylic acids such as 1,2,3-, 1,2,4-benzenetricarboxylic acid, or 1,3,5-benzenetricarboxylic acid (BTC), benzenetetracarboxylic acid, adamantanetetracarboxylic acid (ATC), adamantanedibenzoate (ADB), benzenetribenzoate (BTB), methanetetrabenzoate (MTB), adamantanetetrabenzoate or dihydroxyterephthalic acids such as 2,5-dihydroxyterephthalic acid (DHBDC).

Very particular preference is given to using, inter alia, isophthalic acid, terephthalic acid, 2,5-dihydroxyterephthalic acid, 1,2,3-benzenetricarboxylic acid, 1,3,5-benzenetricarboxylic acid, 2,6-naphthalenedicarboxylic acid, 1,4-naphthalenedicarboxylic acid, 1,2,3,4- and 1,2,4,5-benzenetetracarboxylic acid, camphordicarboxylic acid or 2,2′-bipyridine-5,5′-dicarboxylic acid.

Apart from these at least bidentate organic compounds, the metal organic framework can further comprise one or more monodentate ligands.

The at least one at least bidentate organic compound preferably comprises no boron or phosphorus atoms. In addition, the skeleton of the metal organic framework preferably comprises no boron or phosphorus atoms.

The nonaqueous organic solvent is preferably a C₁₋₆-alkanol, dimethyl sulfoxide (DMSO), N,N-dimethylformamide (DMF), N,N-diethylformamide (DEF), acetonitrile, toluene, dioxane, benzene, chlorobenzene, methyl ethyl ketone (MEK), pyridine, tetrahydrofuran (THF), ethyl acetate, optionally halogenated C₁₋₂₀₀-alkane, sulfolane, glycol, N-methylpyrrolidone (NMP), gamma-butyrolactone, alicyclic alcohols such as cyclohexanol, ketones such as acetone or acetylacetone, cyclic ketones such as cyclohexanone, sulfolene or mixtures thereof.

A C₁₋₆-alkanol is an alcohol having from 1 to 6 carbon atoms; examples are methanol, ethanol, n-propanol, i-propanol, n-butanol, i-butanol, t-butanol, pentanol, hexanol and mixtures thereof.

An optionally halogenated C₁₋₂₀₀-alkane is an alkane which has from 1 to 200 carbon atoms and in which one or more to all hydrogen atoms may be replaced by halogen, preferably chlorine or fluorine, in particular chlorine; examples are chloroform, dichloromethane, tetrachloromethane, dichloroethane, hexane, heptane, octane and mixtures thereof.

Preferred solvents are DMF, DEF and NMP. Particular preference is given to DMF.

The term “nonaqueous” preferably refers to a solvent which has a maximum water content of 10% by weight, more preferably 5% by weight, even more preferably 1% by weight, even more preferably 0.1% by weight, particularly preferably 0.01% by weight, based on the total weight of the solvent.

The maximum water content during the reaction is preferably 10% by weight, more preferably 5% by weight and even more preferably 1% by weight.

The term “solvent” refers to pure solvents or mixtures of different solvents.

Preference is also given to the process step of the reaction of the at least one metal compound with the at least one at least bidentate organic compound being followed by a calcination step. The temperature set here is typically above 250° C., preferably from 300 to 400° C.

The at least bidentate organic compound present in the pores can be removed by means of the calcination step.

In addition or as an alternative thereto, the removal of the at least bidentate organic compound (ligand) from the pores of the porous metal organic framework can be effected by treatment of the framework formed with a nonaqueous solvent. Here, the ligand is removed in a type of “extraction process” and may be replaced by a solvent molecule in the framework. This mild method is particularly useful when the ligand is a high-boiling compound.

The treatment preferably takes at least 30 minutes and can typically be carried out over a period of up to 2 days. This can occur at room temperature or elevated temperature. It is preferably carried out at elevated temperature, for example at least 40° C., preferably 60° C. The extraction is more preferably carried out at the boiling point of the solvent used (under reflux).

The treatment can be carried out in a single vessel by slurrying and stirring the framework. It is also possible to use extraction apparatuses such as Soxhlet apparatuses, in particular industrial extraction apparatuses.

Solvents which can be used are those mentioned above, i.e., for example, C₁₋₆-alkanol, dimethyl sulfoxide (DMSO), N,N-dimethylformamide (DMF), N,N-diethylformamide (DEF), acetonitrile, toluene, dioxane, benzene, chlorobenzene, methyl ethyl ketone (MEK), pyridine, tetrahydrofuran (THF), ethyl acetate, optionally halogenated C₁₋₂₀₀-alkane, sulfolane, glycol, N-methylpyrrolidone (NMP), gamma-butyrolactone, alicyclic alcohols such as cyclohexanol, ketones such as acetone or acetylacetone, cyclic ketones such as cyclohexanone or mixtures thereof.

Preference is given to methanol, ethanol, propanol, acetone, MEK and mixtures thereof.

A very particularly preferred extractant is methanol.

The solvent used for the extraction can be identical to or different from that for the reaction of the at least one metal compound with the at least one at least bidentate organic compound. In particular, in the case of the “extraction”, it is not absolutely necessary but preferred that the solvent is water-free.

The metal organic frameworks of the present invention comprise pores, in particular micropores and/or mesopores. Micropores are defined as pores having a diameter of 2 nm or less and mesopores are defined by a diameter in the range from 2 to 50 nm, in each case corresponding to the definition given in Pure Applied Chem. 45, page 71, in particular page 79 (1976). The presence of micropores and/or mesopores can be checked by means of sorption measurements, with these measurements determining the absorption capacity of the MOF for nitrogen at 77 kelvin in accordance with DIN 66131 and/or DIN 66134.

As indicated above, the metal organic frameworks prepared by the process of the invention have a comparatively low specific surface area but are nevertheless very good for storing hydrogen. The specific surface area of the metal organic frameworks of the invention in powder form is preferably less than 300 m²/g determined by the Langmuir method (N₂) in accordance with DIN 66135 (DIN 66131, 66134). The specific surface area is more preferably less than 250 m²/g, even more preferably less than 200 m²/g, even more preferably less than 150 m²/g and particularly preferably less than 100 m²/g.

However, a certain minimum porosity has to be ensured. The specific surface area is preferably at least 10 m²/g, more preferably at least 30 m²/g.

Frameworks which are present as shaped bodies can have a lower specific surface area.

The metal organic framework can be in powder form or be present as agglomerate. The framework can be used as such or is converted into a shaped body. Accordingly, a further aspect of the present invention is a shaped body comprising a framework according to the invention.

Preferred methods of producing shaped bodies are extrusion or tableting. In the production of shaped bodies, the framework can comprise further materials such as binders, lubricants or other additives which are added during production. It is likewise conceivable for the framework to comprise further constituents such as absorbents such as activated carbon or the like.

The possible geometries of the shaped bodies are subject to essentially no restrictions. For example, pellets such as disk-shaped pellets, pills, spheres, granulated material, extrudates such as rods, honeycombs, grids or hollow bodies, inter alia, are possible.

To produce these shaped bodies, it is in principle possible to use all suitable processes. In particular, the following procedures are preferred:
Kneading/pan milling of the framework either alone or together with at least one binder and/or at least one pasting agent and/or at least one template compound to give a mixture; shaping of the resultant mixture by means of at least one suitable method such as extrusion; optionally washing and/or drying and/or calcination of the extrudate; optionally finishing.
Tableting together with at least one binder and/or other auxiliary.
Application of the framework to at least one optionally porous support material. The material obtained can then be processed further by the above-described method to produce a shaped body.
Application of the framework to at least one optionally porous substrate.

Kneading/pan milling and shaping can be carried out by any suitable process, as described, for example, in Ullmanns Enzyklopadie der Technischen Chemie, 4th edition, volume 2, p. 313 ff. (1972).

For example, the kneading/pan milling and/or shaping can be carried out by means of a piston press, roller presses in the presence or absence of at least one binder, compounding, pelletization, tableting, extrusion, coextrusion, foaming, spinning, coating, granulation, preferably spray granulation, spraying, spray drying or a combination of two or more of these methods.

Very particular preference is given to producing pellets and/or tablets.

Kneading and/or shaping can be carried out at elevated temperatures, for example in the range from room temperature to 300° C., and/or at superatmospheric pressure, for example in the range from atmospheric pressure to a few hundred bar, and/or in a protective gas atmosphere, for example in the presence of at least one noble gas, nitrogen or a mixture of two or more thereof.

The kneading and/or shaping is, in a further embodiment, carried out with addition of at least one binder which can in principle be any chemical compound which ensures the viscosity of the composition to be kneaded and/or shaped which is desired for kneading and/or shaping. Accordingly, binders can, for the purposes of the present invention, be both viscosity-increasing and viscosity-reducing compounds.

Among preferred binders, mention may be made of, for example, aluminum oxide or binders comprising aluminum oxide as are described, for example, in WO 94/29408, silicon dioxide as is described, for example, in EP 0 592 050 A1, mixtures of silicon dioxide and aluminum oxide as are described, for example, in WO 94/13584, clay minerals as are described, for example, in JP 03-037156 A, for example montmorillonite, kaolin, bentonite, halloysite, dickite, nacrite and anauxite, alkoxysilanes as are described, for example, in EP 0 102 544 B1, for example tetraalkoxysilanes such as tetramethoxysilane, tetraethoxysilane, tetrapropoxysilane, tetrabutoxysilane, or, for example, trialkoxysilanes such as trimethoxysilane, triethoxysilane, tripropoxysilane, tributoxysilane, alkoxytitanates, for example tetraalkoxytitanates such as tetramethoxytitanate, tetraethoxytitanate, tetrapropoxytitanate, tetrabutoxytitanate, or, for example, trialkoxytitanates such as trimethoxytitanate, triethoxytitanate, tripropoxytitanate, tributoxytitanate, alkoxyzirconates, for example tetraalkoxyzirconates such as tetramethoxyzirconate, tetraethoxyzirconate, tetrapropoxyzirconate, tetrabutoxy-zirconate, or, for example, trialkoxyzirconates such as trimethoxyzirconate, triethoxyzirconate, tripropoxyzirconate, tributoxyzirconate, silica sols, amphiphilic substances and/or graphites.

As viscosity-increasing compound, it is also possible, for example, to use, if appropriate in addition to the abovementioned compounds, an organic compound and/or a hydrophilic polymer such as cellulose or a cellulose derivative, for example methyl cellulose, and/or a polyacrylate and/or a polymethacrylate and/or a polyvinyl alcohol and/or a polyvinylpyrrolidone and/or a polyisobutene and/or a polytetrahydrofuran and/or a polyethylene oxide.

As pasting agent, preference is given to using, inter alia, water or at least one alcohol such as a monoalcohol having from 1 to 4 carbon atoms, for example methanol, ethanol, n-propanol, isopropanol, 1-butanol, 2-butanol, 2-methyl-1-propanol or 2-methyl-2-propanol, or a mixture of water and at least one of the abovementioned alcohols or a polyhydric alcohol such as a glycol, preferably a water-miscible polyhydric alcohol, either alone or in admixture with water and/or at least one of the abovementioned monohydric alcohols.

Further additives which can be used for kneading and/or shaping are, inter alia, amines or amine derivatives such as tetraalkylammonium compounds or amino alcohols and carbonate-comprising compounds such as calcium carbonate. Such further additives are described, for instance, in EP 0 389 041 A1, EP 0 200 260 A1 or WO 95/19222.

The order in which the additives such as template compound, binder, pasting agent, viscosity-increasing substance are added during shaping and kneading is in principle not critical.

In a further, preferred embodiment, the shaped body obtained by kneading and/or shaping is subjected to at least one drying step which is generally carried out at a temperature in the range from 25 to 500° C., preferably in the range from 50 to 500° C. and particularly preferably in the range from 100 to 350° C. It is likewise possible to carry out drying under reduced pressure or in a protective gas atmosphere or by spray drying.

In a particularly preferred embodiment, at least one of the compounds added as additives is at least partly removed from the shaped body during this drying step.

The present invention further provides a porous metal organic framework which can be obtained from a process according to the invention for preparing it. Here, the framework preferably has the specific surface areas (determined by the Langmuir method) indicated above.

The present invention further provides for the use of a porous metal organic framework according to the invention for the absorption of at least one substance for the purpose of storage, separation, controlled release or chemical reaction and also as support, for example for metals, metal oxides, metal sulfides or other framework structures.

If the porous metal organic framework of the invention is used for storage, this is preferably carried out in a temperature range from −200° C. to +80° C. Greater preference is given to a temperature range from −40° C. to +80° C.

The at least one substance can be a gas or a liquid. The substance is preferably a gas.

For the purposes of the present invention, the terms “gas” and “liquid” are used in the interests of simplicity, but gas mixtures and liquid mixtures or liquid solutions are likewise encompassed by the term “gas” or “liquid”.

Preferred gases are hydrogen, natural gas, town gas, hydrocarbons, in particular methane, ethane, ethyne, acetylene, propane, n-butane and i-butane, carbon monoxide, carbon dioxide, nitrogen oxides, oxygen, sulfur oxides, halogens, halogenated hydrocarbons, NF₃, SF₆, ammonia, boranes, phosphanes, hydrogen sulfide, amines, formaldehyde, noble gases, in particular helium, neon, argon, krypton and xenon.

However, the at least one substance can also be a liquid. Examples of such a liquid are disinfectants, inorganic or organic solvents, fuels, in particular gasoline or diesel, hydraulic fluid, radiator fluid, brake fluid or an oil, in particular machine oil. The liquid can also be halogenated aliphatic or aromatic, cyclic or acyclic hydrocarbons or mixtures thereof. In particular, the liquid can be acetone, acetonitrile, aniline, anisole, benzene, benzonitrile, bromobenzene, butanol, tert-butanol, quinoline, chlorobenzene, chloroform, cyclohexane, diethylene glycol, diethyl ether, dimethylacetamide, dimethylformamide, dimethyl sulfoxide, dioxane, glacial acetic acid, acetic anhydride, ethyl acetate, ethanol, ethylene carbonate, ethylene dichloride, ethylene glycol, ethylene glycol dimethyl ether, formamide, hexane, isopropanol, methanol, methoxypropanol, 3-methyl-1-butanol, methylene chloride, methyl ethyl ketone, N-methylformamide, N-methylpyrrolidone, nitrobenzene, nitromethane, piperidine, propanol, propylene carbonate, pyridine, carbon disulfide, sulfolane, tetrachloroethene, carbon tetrachloride, tetrahydrofuran, toluene, 1,1,1-trichloroethane, trichloroethylene, triethylamine, triethylene glycol, triglyme, water or a mixture thereof.

Furthermore, the at least one substance can be an odorous substance.

The odorous substance is preferably a volatile organic or inorganic compound which comprises at least one of the elements nitrogen, phosphorus, oxygen, sulfur, fluorine, chlorine, bromine or iodine or is an unsaturated or aromatic hydrocarbon or a saturated or unsaturated aldehyde or a ketone. More preferred elements are nitrogen, oxygen, phosphorus, sulfur, chlorine, bromine; and particular preference is given to nitrogen, oxygen, phosphorus and sulfur.

In particular, the odorous substance is ammonia, hydrogen sulfide, sulfur oxides, nitrogen oxides, ozone, cyclic or acyclic amines, thiols, thioethers and aldehydes, ketones, esters, ethers, acids or alcohols. Particular preference is given to ammonia, hydrogen sulfide, organic acids (preferably acetic acid, propionic acid, butyric acid, isobutyric acid, valeric acid, isovaleric acid, caproic acid, heptanoic acid, lauric acid, pelargonic acid) and also cyclic or acyclic hydrocarbons which comprise nitrogen or sulfur and saturated or unsaturated aldehydes such as hexanal, heptanal, octanal, nonanal, decanal, octenal or nonenal and in particular volatile aldehydes such as butyraldehyde, propionaldehyde, acetaldehyde and formaldehyde and also fuels such as gasoline, diesel (constituents).

The odorous substances can also be fragrances which are used, for example, for producing perfumes. Examples of fragrances or oils which release such fragrances are: essential oils, basil oil, geranium oil, mint oil, cananga oil, cardamom oil, lavender oil, peppermint oil, nutmeg oil, chamomile oil, eucalyptus oil, rosemary oil, lemon oil, lime oil, orange oil, bergamot oil, muscatel sage oil, coriander oil, cypress oil, 1,1-dimethoxy-2-phenylethane, 2,4-dimethyl-4-phenyltetrahydrofuran, dimethyltetrahydrobenzaldehyde, 2,6-dimethyl-7-octen-2-ol, 1,2-diethoxy-3,7-dimethyl-2,6-octadiene, phenylacetaldehyde, rose oxide, ethyl 2-methylpentanoate, 1-(2,6,6-trimethyl-1,3-cyclohexadien-1-yl)-2-buten-1-one, ethyl vanillin, 2,6-dimethyl-2-octenol, 3,7-dimethyl-2-octenol, tert-butylcyclohexyl acetate, anisyl acetate, allyl cyclohexyloxyacetate, ethyllinalool, eugenol, coumarin, ethyl acetoacetate, 4-phenyl-2,4,6-trimethyl-1,3-dioxane, 4-methylene-3,5,6,6-tetramethyl-2-heptanone, ethyl tetrahydrosafranate, geranyl nitrile, cis-3-hexen-1-ol, cis-3-hexenyl acetate, cis-3-hexenyl methyl carbonate, 2,6-dimethyl-5-hepten-1-al, 4-(tricyclo[5.2.1.0]decylidene)-8-butanal, 5-(2,2,3-trimethyl-3-cyclopentenyl)-3-methylpentan-2-ol, p-tert-butyl-alpha-methylhydrocinnamalde-hyde, ethyl [5.2.1.0]tricyclodecanecarboxylate, geraniol, citronellol, citral, linalool, linalyl acetate, ionone, phenylethanol and mixtures thereof.

For the purposes of the present invention, a volatile odorous substance preferably has a boiling point or boiling point range below 300° C. The odorous substance is more preferably a readily volatile compound or mixture. The odorous substance particularly preferably has a boiling point or boiling range below 250° C., more preferably below 230° C., particularly preferably below 200° C.

Preference is likewise given to odorous substances which have a high volatility. The vapor pressure can be employed as a measure of the volatility. For the purposes of the present invention, a volatile odorous substance preferably has a vapor pressure of more than 0.001 kPa (20° C.). The odorous substance is more preferably a readily volatile compound or mixture. The odorous substance particularly preferably has a vapor pressure of more than 0.01 kPa (20° C.), more preferably a vapor pressure of more than 0.05 kPa (20° C.). Particular preference is given to the odorous substances having a vapor pressure of more than 0.1 kPa (20° C.).

### EXAMPLES

### Example 1 Preparation of an Sc terephthalate MOF

4 g of Sc(NO₃)₃*H₂O and 4 g of terephthalic acid are dissolved in 350 ml of DMF and stirred at 130° C. for 19 hours. The solid obtained is filtered off, washed with 2×50 ml of DMF and 3×50 ml of methanol and predried at 200° C. for 17 hours in a vacuum drying oven. The material is finally calcined at 290° C. for 48 hours in a muffle furnace (100 l/h of air).

3.51 g of a slightly yellowish powder having a uniform appearance are obtained. The diffraction pattern is shown in FIG. 2. The framework has a surface area determined using N₂ of only 68 m²/g (Langmuir evaluation). Elemental analysis indicates 15.2% by weight of Sc and 49.6% of carbon.

### Comparative Example 2 Hydrothermal Preparation of an Sc terephthalate MOF

(Synthesis by the method of Miller et al., Chem. Commun. (2005) 3850)

3.81 g of Sc(NO₃)₃*H₂O and 2.12 g of terephthalic acid are suspended in 80 ml of water and stirred at RT for 1 hour.

The reaction mixture is left to stand at 220° C. for 48 hours under the autogenous pressure in a Berghof autoclave (Teflon liner).

After filtration, the filter cake is washed with 20 ml of H₂O and twice with 20 ml of ethanol. The yellow residue is suspended in 80 ml of EtOH and treated with ultrasound for two hours. After the suspension has been filtered again, the solid is washed twice with 50 ml of ethanol and dried at 140° C. for 72 hours in a vacuum drying oven.

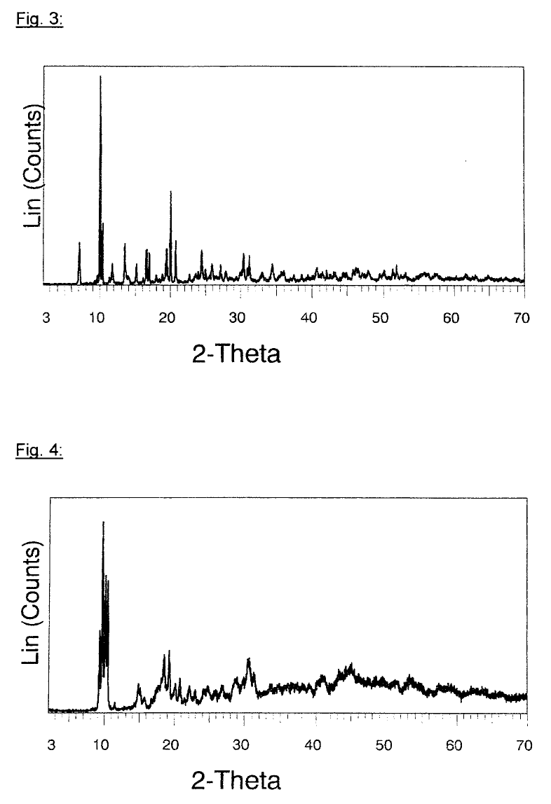

The solid, which has a nonuniform yellow color, is calcined at 290° C. for 48 hours in a drying oven (air stream: 100 l/h). This gives 2.33 g of a slightly yellowish solid. The diffraction pattern is shown in FIG. 3. The framework has a surface area determined using N₂ of 366 m²/g (Langmuir evaluation). Elemental analysis indicates 20.6% by weight of Sc and 41.6% by weight of carbon.

### Comparative Example 3 MOF-5

MOF-5 is known to those skilled in the art as a suitable framework for the storage of H₂ at 77 K. A suitable synthetic method is disclosed in, for example, WO-A 03/102000.

The material has a surface area determined using N₂ of 2740 m²/g (Langmuir method).

### Example 4

### Preparation of a Y Terephthalate MOF

5 g of Y(NO₃)₃*H₂O and 3.25 g of terephthalic acid are dissolved in 350 ml of DMF and stirred at 140° C. for 19 hours. The solid obtained is filtered off, washed with 3×50 ml of DMF and 4×50 ml of methanol and predried at 200° C. for 17 hours in a vacuum drying oven. The material is finally calcined at 290° C. for 48 hours in a muffle furnace (100 l/h of air). 3.81 g of a white powder having a uniform appearance are obtained. The diffraction pattern is shown in FIG. 4. The framework has a surface area determined using N₂ of only 83 m²/g (Langmuir evaluation). Elemental analysis indicates 26.6% by weight of yttrium and 42.5% by weight of carbon.

### Example 5

### Hydrogen Sorption at 77 K

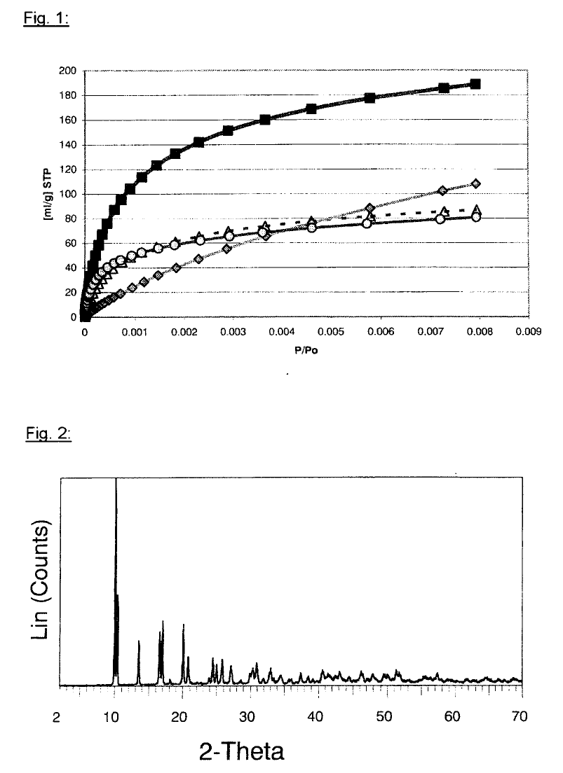

FIG. 1 shows the comparison of the H₂ absorption for three materials.

Here, the curves shown in FIG. 1 are denoted as follows:

The measurements were carried out on a commercially available Autosorb-1 instrument from Quantachrome. The measurement temperature was 77.3 K. Before the measurement, the samples are each pretreated under reduced pressure for 4 hours at room temperature and subsequently for a further 4 hours at 200° C.

Although the surface areas determined for both Sc MOFs are significantly lower than for MOF-5, these unexpectedly absorb a large amount of hydrogen. Among the Sc MOFs, the material according to the invention (Ex. 1) is surprisingly significantly superior in terms of H₂ storage to the material known from the literature, despite the significantly lower surface area of the former. The Y MOF (Ex. 4), too, absorbs an astonishingly large amount of hydrogen for its low surface area.

### Example 6 Preparation of a Gd 4,5-imidazole dicarboxylate MOF

9.70 g (21.49 mmol) Gd(NO₃)₃*6H₂O and 5.03 g (32.24 mmol) 4,5-imidazole dicarboxylic acid are dissolved in 300 ml DMF and stirred at 130° C. for 18 hours. The solid obtained is filtered off, washed with 3×50 ml DMF and 4×50 ml MeOH and dried at 150° C. for 16 h in a vacuum drying oven.

9.82 g of a colourless powder are obtained. The framework has a surface area determined using N₂ of only 49 m²/g auf (Langmuir evaluation). Elemental analysis indicates 31.0% by weight of Gd, 24.8% by weight of C, 12.7% by weight of N and 2,2% by weight of H. The framework material shows a diffraction pattern of a new MOF structure.

### Example 7

### Preparation of an Sm 4,5-imidazole dicarboxylate MOF

10.00 g (22.50 mmol) Sm(NO₃)₃*6H₂O and 5.27 g (33.75 mmol) 4,5-imidazole dicarboxylic acid are dissolved in 300 ml DMF and stirred at 130° C. for 18 hours. The solid obtained is filtered off, washed with 3×50 ml DMF and 4×50 ml MeOH and dried at 150° C. for 16 h in a vacuum drying oven.

10.32 g of a slightly yellowish powder are obtained. The framework has a surface area determined using N₂ of only 41 m²/g auf (Langmuir evaluation). Elemental analysis indicates 30.0% by weight of Sm, 25.7% by weight of C, 13.3% by weight of N and 2.3% by weight of H. The framework material shows a diffraction pattern of a new MOF structure.

### Example 8

### Preparation of a Y 2,6-naphthaline dicarboxylate MOF

5.0 g Y(NO₃)₃*4H₂O and 5.5 g 2,6-Naphthalindicarbonsäure are dissolved in 350 ml DMF and stirred at 130° C. for 19 hours. The solid obtained is filtered off, washed with 3×50 ml DMF and 4×50 ml MeOH and predried at 200° C. for 16 h in a vacuum drying oven. The material is finally calcined at 290° C. for 48 hors in a muffle furnace.

5.6 g of an ochre powder are obtained. The framework has a surface area determined using N₂ of only 28 m²/g auf (Langmuir evaluation). The framework material shows a diffraction pattern of a new MOF structure.

1. A process for preparing a porous metal organic framework, comprising:
reacting at least one metal compound with at least one at least bidentate organic compound which can coordinate to the metal, where the metal is Sc^{III}, Y^{III} or a trivalent lanthanide and the organic compound has at least two atoms which are selected independently from the group consisting of oxygen, sulfur and nitrogen and via which the organic compound can coordinate to the metal, in the presence of a nonaqueous organic solvent, with the reaction being carried out with stirring and at a pressure of not more than 2 bar (absolute).

2. The process according to claim 1, wherein the reaction is carried out at not more than 1230 mbar (absolute).

3. The process according to claim 1, wherein the reaction is carried out without additional base.

4. The process according to claim 1, wherein the at least bidentate organic compound is a dicarboxylic, tricarboxylic or tetracarboxylic acid or a sulfur analogue thereof.

5. The process according to claim 1, wherein the metal is Sc^{III}, Y^{III}, La^{III}, Nd^{III} or Ce^{III}.

6. The process according to claim 1, wherein the nonaqueous organic solvent is a C₁₋₆-alkanol, DMSO, DMF, DEF, acetonitrile, toluene, dioxane, benzene, chlorobenzene, MEK, pyridine, THF, ethyl acetate, optionally halogenated C₁₋₂₀₀-alkane, sulfolane, glycol, NMP, gamma-butyrolactone, alicyclic alcohols, ketones, cyclic ketones, sulfolene or a mixture thereof.

7. The process according to claim 1, wherein the framework formed is after-treated with an organic solvent after the reaction.

8. The process according to claim 1, wherein a calcination step is carried out after the reaction.

9. The process according to claim 1, wherein the metal compound is nonionic and/or the counterion to the metal cation is derived from a protic solvent.

10. A porous metal organic framework obtained from the process according to claim 1.

11. The framework according to claim 10 which, as powder, has a specific surface area of less than 300 m²/g determined by the Langmuir method (N₂).

12. A method of absorbing at least one substance for the purpose of storage, separation, controlled release or chemical reactions comprising contacting the porous metal organic framework according to claim 10 with the at least one substance.

13. The method according to claim 12, wherein the substance is a gas.

14. The method according to claim 13, wherein the gas is hydrogen, natural gas, town gas or methane.

15. The process according to claim 1, wherein the reaction is carried out at atmospheric pressure.

16. A support material comprising the porous metal organic framework according to claim 10.
